(19) United States
(12) Patent Application Publication
(10) Pub. No.: US 2024/0222673 A1
(43) Pub. Date: Jul. 4, 2024

(54) BIPOLAR MEMBRANE AND METHOD OF MANUFACTURING THE SAME

(71) Applicant: Industrial Technology Research Institute, Hsinchu (TW)

(72) Inventors: Cheng-Hsiu Tsai, Hsinchu City (TW); Chiu-Tung Wang, Changhua County (TW); Li-Duan Tsai, Hsinchu City (TW)

(73) Assignee: Industrial Technology Research Institute, Hsinchu (TW)

(21) Appl. No.: 18/190,139

(22) Filed: Mar. 27, 2023

(30) Foreign Application Priority Data
Dec. 27, 2022 (TW) 111150085

(51) Int. Cl. H01M 8/1062; H01M 8/1039; H01M 8/106; H01M 8/1069

(52) U.S. Cl. CPC H01M 8/1062; H01M 8/1039; H01M 8/106; H01M 8/1069; H01M 2008/1095

(57) ABSTRACT

A bipolar membrane and a method of manufacturing the same are provided. The bipolar membrane includes a porous support material, a cation exchange membrane (CEM) and an anion exchange membrane (AEM). The porous support material has opposing first and second sides. The CEM is disposed on the first side of the porous support material, and the material of the CEM penetrates into the pores of the first side and combines with the porous support material. The AEM is disposed on the second side of the porous support material, and the material of the AEM penetrates into the pores of the second side and combines with the porous support material. The CEM is not in contact with the AEM.

### CROSS-REFERENCE TO RELATED APPLICATION

This application claims the priority benefit of Taiwan application serial no. 111150085, filed on Dec. 27, 2022. The entirety of the above-mentioned patent application is hereby incorporated by reference herein and made a part of this specification.

### TECHNICAL FIELD

The disclosure relates to a high-efficiency bipolar membrane and a manufacturing method thereof.

### BACKGROUND

In order to meet the goal of net zero carbon emissions by 2050, traditional energy-intensive industries (such as petrochemical industry, steel industry, semiconductor industry, cement industry, etc.) urgently need corresponding strategies to cope with and transform towards low-carbon or zero-carbon processes. Applications related to electrical grid regulation, alternative energy or renewable energy must also focus on their green power storage and electrical grid security, or the use of low-carbon energy chemicals. Among them, hydrogen can not only promote low-carbon industries, but also improve the competitiveness of products in the face of international carbon fees.

However, at this stage, there are still many challenges in the key technologies of hydrogen energy breakthroughs, such as effectively improving conversion efficiency and reducing costs. Although the bipolar membrane is commercially available at present, there is still a need for improvement in the overall electrochemical properties and interface stability.

### SUMMARY

A bipolar membrane of the disclosure includes a porous support material, a cation exchange membrane and an anion exchange membrane. The porous support has opposing first and second sides. The cation exchange membrane is disposed on the first side of the porous support material, wherein a material of the cation exchange membrane penetrates into pores of the first side and combines with the porous support material. The anion exchange membrane is disposed on the second side of the porous support material, wherein a material of the anion exchange membrane penetrates into pores of the second side and combines with the porous support material. The cation exchange membrane is not in contact with the anion exchange membrane.

A method of manufacturing a bipolar membrane of the disclosure includes the following steps. An anion exchange membrane is formed on a substrate, and then a porous support material having opposing first and second sides covers on the anion exchange membrane, and a material of the anion exchange membrane is allowed to penetrate and fill into pores of the second side of the porous support material. Then, a cation exchange membrane is formed on the first side of the porous support material, and allowing a material of the cation exchange membrane to penetrate and fill into pores of the first side of the porous support material, wherein the material of the cation exchange membrane is not in contact with the material of the anion exchange membrane. Afterwards, the substrate is removed.

In order to make the above-mentioned features and advantages of the disclosure more comprehensible, the following specific embodiments are described in detail together with the accompanying drawings.

### BRIEF DESCRIPTION OF THE DRAWINGS

FIG. 1 is a schematic cross-sectional view of a bipolar membrane according to a first embodiment of the disclosure.

FIG. 2 is a schematic cross-sectional view of a bipolar membrane according to a second embodiment of the disclosure.

FIG. 3 is a schematic cross-sectional view of a bipolar membrane according to a third embodiment of the disclosure.

FIG. 4A to FIG. 4F are schematic cross-sectional views of a manufacturing process of a bipolar membrane according to a fourth embodiment of the disclosure.

FIG. 5 is a scanning electron microscope (SEM) image of a cross-section of a bipolar membrane of Experimental Example 4.

FIG. 6 is a scanning electron microscope (SEM) image of a cross-section of a bipolar membrane of Experimental Example 8.

FIG. 7 is an electrical analysis diagram obtained by placing the bipolar membrane of Experimental Example 1 in electrolytes with different concentrations.

FIG. 8 is an electrical analysis diagram obtained by placing the BP-1E bipolar membrane of Comparative Example 2 in electrolytes with different concentrations.

### DESCRIPTION OF THE EMBODIMENTS

Embodiments are listed below and described in detail with accompanying drawings, but the provided embodiments are not intended to limit the scope of the disclosure. In addition, the dimensions of the components in the drawings are drawn for the convenience of description, and do not represent their actual size ratios.

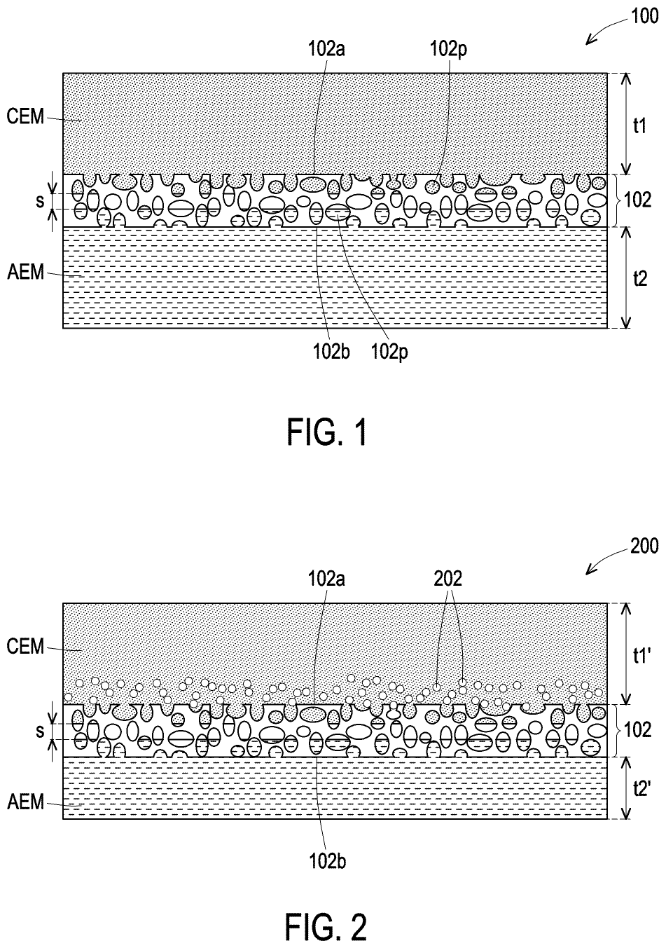

FIG. 1 is a schematic cross-sectional view of a bipolar membrane according to a first embodiment of the disclosure.

Referring to FIG. 1, a bipolar membrane 100 of this embodiment includes a porous support material 102, a cation exchange membrane CEM and an anion exchange membrane AEM. The porous support material 102 has opposing first side 102a and second side 102b. The cation exchange membrane CEM is disposed on the first side 102a of the porous support material 102, and the material of the cation exchange membrane CEM penetrates into the pores 102p of the first side 102a to combine with the porous support material 102. The anion exchange AEM is disposed on the second side 102b of the porous support material 102, and the material of the anion exchange membrane AEM penetrates into the pores 102p of the second side 102b to combine with the porous support material 102. The cation exchange membrane CEM is not in contact with the anion exchange membrane AEM. Therefore, there is a distance s between the cation exchange membrane CEM and the anion exchange membrane AEM, and the distance s is, for example, less than 30 μm. In one embodiment, the distance s between the cation exchange membrane CEM and the anion exchange membrane AEM is larger than several micrometers (μm).

The porous support material 102 includes a glass fiber cloth, an electrospun polyvinylidene fluoride (PVDF) nanofiber membrane, a non-woven graphite cloth, or a polymer fabric. The porous support material 102 contains pores 102p. These pores 102p are exposed at the first side 102a and the second side 102b, and the pores 102p in the porous support material 102 are communicated with each other. The material of the polymer fabric is, for example, polyetheretherketone (PEEK), polyester, polypropylene, perfluoroalkoxy (PFA), or a combination thereof.

The ratio (t2/t1) of the thickness t2 of the anion exchange membrane AEM to the thickness t1 of the cation exchange membrane CEM can be 0.3-1. For example, the thickness t2 of the anion exchange membrane AEM can be 12-40 μm, and the thickness t1 of the cation exchange membrane CEM can be 40-80 μm. In one embodiment, t2/t1 is 0.3-0.5.

In one embodiment, the material of the cation exchange membrane includes a polymer represented by formula 1,

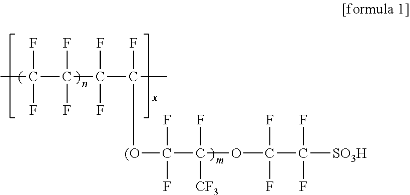

in formula 1, n is 5-14, m is 1-2, and x is 200-1000.

In another embodiment, the material of the cation exchange membrane includes a polymer having repeating units represented by formula 2, formula 3 and formula 4,

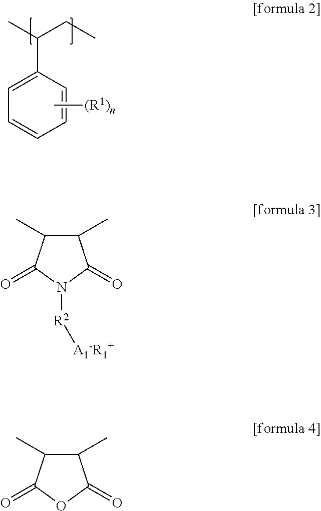

in formula 2, R¹ represents C₁-C₈ alkyl group, C₁-C₈ cycloalkyl group, C₁-C₈ alkoxy group, or C₁-C₈ alkoxyalkyl group, and n is 0 or an integer of 1-5; and in formula 3, R² represents C₆-C₁₆ arylene group, C₁-C₈ alkylene group, C₁-C₈ cycloalkylene group, or C₁-C₈ alkoxy alkylene group, A₁⁻ represents SO₃⁻, NO₃⁻, or COO⁻, and R₁⁺ represents H⁺, Li⁺, Na⁺, K⁺, or NH₄⁺.

For example, the material of the cation exchange membrane includes a polymer represented by formula 5,

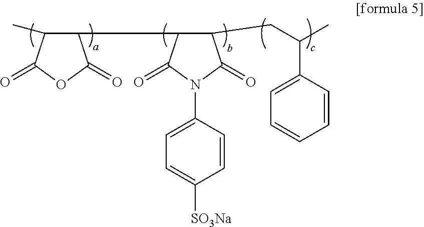

in formula 5, the ratio of a to (b+c) is between 60:40 and 85:15.

In one embodiment, the material of the anion exchange membrane includes a polymer having repeating units represented by formula 6 and formula 7,

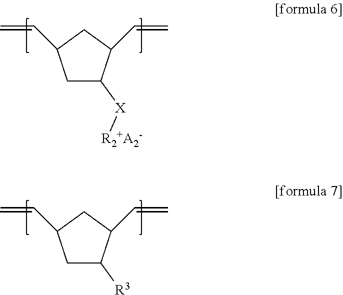

in formula 6, X represents [symbol] CH₂ [symbol] Y [symbol] CH₂ [symbol] , i and j are each independently 0 or an integer of 1-6, and Y is —O—, —S—, —CH₂—, or —NH—; A₂ represents F⁻, Cl⁻, Br⁻, I⁻, OH⁻, HCO₃⁻, HSO₄⁻, SbF₆⁻, BF₄⁻, H₂PO₄⁻, H₂PO₃⁻, or H₂PO₂⁻; and R₂⁺ represents

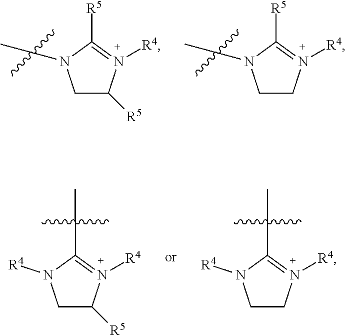

wherein R⁴ and R⁵ are independently hydrogen or C₁-C₈ alkyl group; and in formula 7, R³ represents a C₁-C₈ alkyl group.

For example, the material of the anion exchange membrane includes a polymer represented by formula 8,

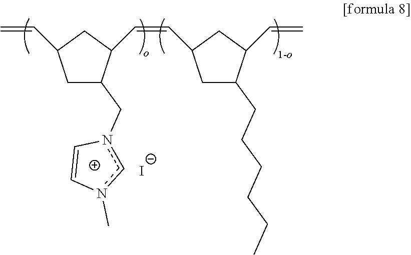

in formula 8, o is 0.1-0.99

In another embodiment, the anion exchange membrane includes a polymer polymerized by a styrene-based monomer, an ammonium-containing heterocyclic monomer, and a monomer having conjugated double bonds or an acrylate ester monomer.

For example, the material of the anion exchange membrane includes a polymer represented by formula 9,

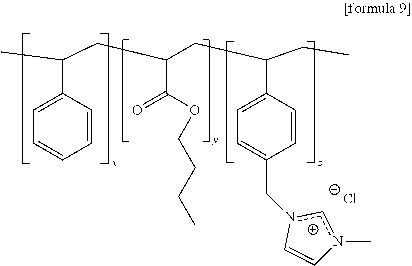

in formula 9, a ratio of z to x is between 1:10 and 50:1, and a ratio of z to y is between 1:10 and 50:1.

FIG. 2 is a schematic cross-sectional view of a bipolar membrane according to a second embodiment of the disclosure, the same or similar parts and components are represented by the same numeral references as those in the first embodiment, and the relevant content of the same or similar parts and components can also refer to the content of the first embodiment, so details are not repeated here.

In FIG. 2, in addition to the porous support material 102, the cation exchange membrane CEM and the anion exchange membrane AEM, the bipolar membrane 200 further includes a first interface additive 202, and the loading can be 0.01 mg/cm²-0.15 mg/cm². The first interface additive 202 is disposed in the cation exchange membrane CEM and located on the first side 102a of the porous support material 102. The first interface additive 202 includes acidified conductive carbon material or metal oxide powder. The “acidified conductive carbon material” herein refers to the product obtained by treating conductive carbon material with acid, so that a surface the conductive carbon material (such as conductive carbon powder) becomes hydrophilic, that is, the acidified conductive carbon material is hydrophilic while the original conductive carbon material before modification is less hydrophilic and will float on the water. In one embodiment, the surface of the acidified conductive carbon material has a carbonyl group, a carboxyl group, or a nitrate group. The specific surface area of the conductive carbon material before and after acidification is also different. For example, the specific surface area of the conductive carbon material before acidification is about 800 m²/g or more, and the specific surface area of the acidified conductive carbon material obtained after acidification is about 390 m²/g or more. As for the material of the metal oxide powder such as boron oxide, aluminum oxide, titanium oxide, silicon oxide, cerium oxide, antimony oxide, tin oxide, or a combination thereof, the particle size can be 5 nm to 50 nm. The metal oxide powder has the effect of improving the water balance in the cation exchange membrane CEM.

Since the first interface additive 202 can improve the water balance and/or ion transport balance of the cation exchange membrane CEM, the conductivity of the cation exchange membrane CEM will increase. In order to cope with the conductivity change of the cation exchange membrane CEM, it can be needed to thin or thicken the thickness t2′ of the anion exchange membrane AEM, so that the time for anions and cations to reach the center of the porous support material 102 is the same. In some embodiments, when the conductivity of the cation exchange membrane CEM increases, the ratio (t2′/t1′) of the thickness t2′ of the anion exchange membrane AEM to the thickness t1′ of the cation exchange membrane CEM can be 0.3-0.5.

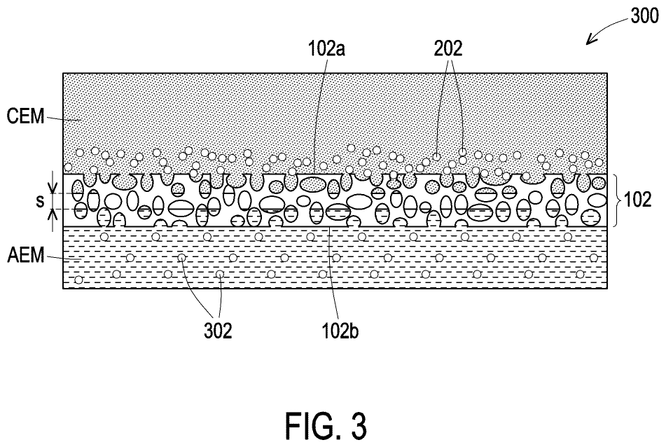

FIG. 3 is a schematic cross-sectional view of a bipolar membrane according to a third embodiment of the disclosure, the same or similar parts and components are denoted by the same numeral references as those in the second embodiment, and the relevant content of the same or similar parts and components can also refer to the content of the second embodiment, so details are not repeated here.

In FIG. 3, in addition to the porous support material 102, the cation exchange membrane CEM, the anion exchange membrane AEM, and the first interface additive 202, the bipolar membrane 300 further includes a second interface additive 302, and the content of the second interface additive 302 can be 5-10 wt % of the anion exchange membrane material. The second interface additive 302 is evenly dispersed in the anion exchange membrane AEM. The second interface additive 302 includes acidified conductive carbon material or metal oxide powder. In one embodiment, the surface of the acidified conductive carbon material has a carbonyl group, a carboxyl group, or a nitrate group. The specific surface area of the acidified conductive carbon material is, for example, above 390 m²/g. The material of the above-mentioned metal oxide powder, is, for example, boron oxide, aluminum oxide, titanium oxide, silicon oxide, cerium oxide, antimony oxide, tin oxide, or a combination thereof. The second interface additive 302 can improve the water balance and ion transport balance of the anion exchange membrane AEM, thereby increasing the conductivity of the anion exchange membrane AEM.

In another embodiment, the bipolar membrane in FIG. 1 may further includes the above-mentioned second interface additive evenly dispersing in the anion exchange membrane AEM.

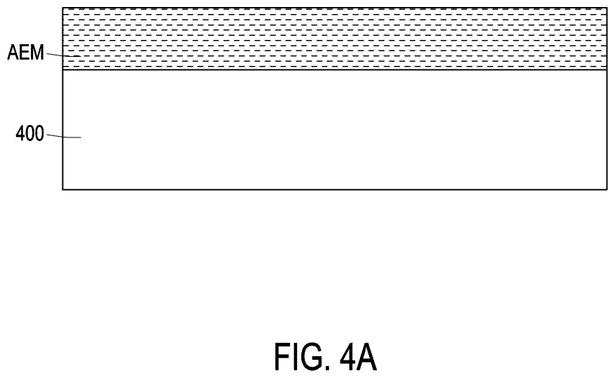

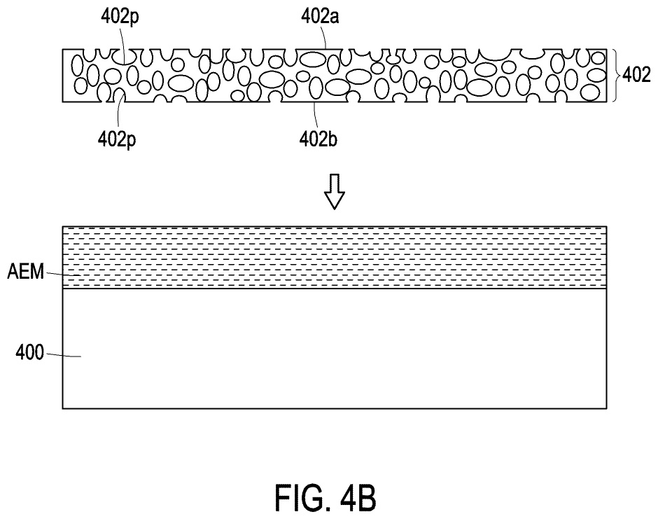

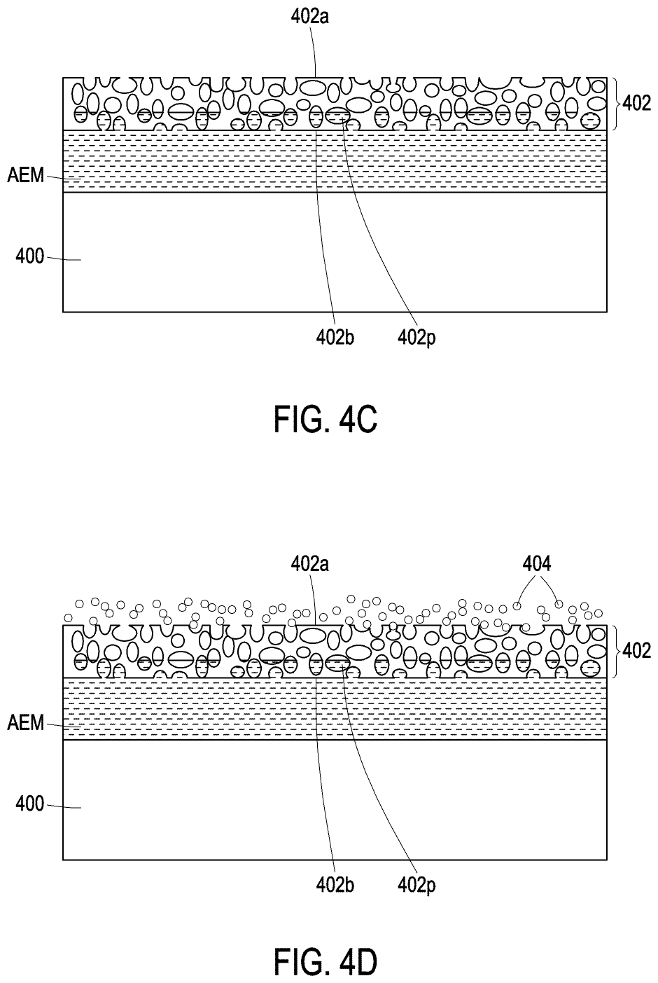

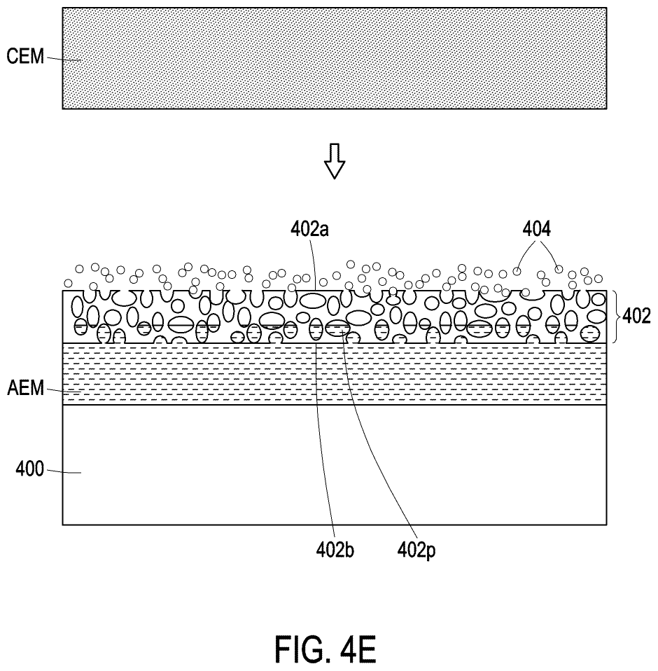

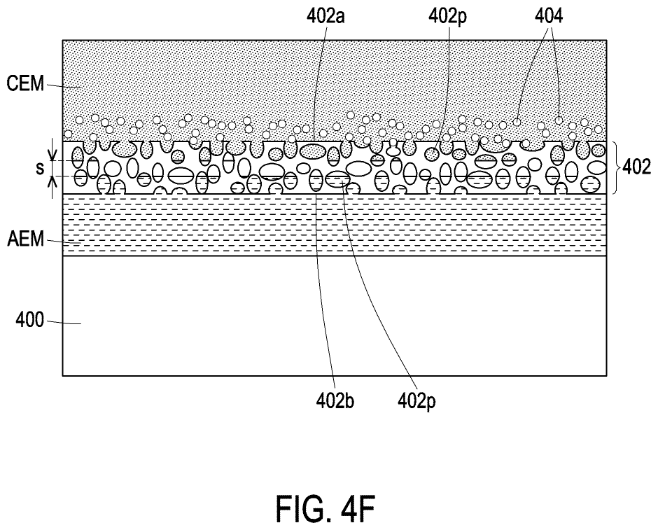

FIG. 4A to FIG. 4F are schematic cross-sectional views of a manufacturing process of a bipolar membrane according to a fourth embodiment of the disclosure.

Referring to FIG. 4A first, an anion exchange membrane AEM is formed on a substrate 400. The substrate 400 can be any support material, and preferably a substrate that can withstand subsequent high temperature steps is used. In one embodiment, the method of forming the anion exchange membrane AEM on the substrate 400 is, for example, preparing a polymer solution containing the material of the anion exchange membrane AEM, and then coating it on the substrate 400. In another embodiment, the method of forming the anion exchange membrane AEM includes adding a second interface additive during the process of forming the anion exchange membrane AEM on the substrate 400, for example, dispersing the second interface additive in the material of the anion exchange membrane AEM (not shown), and then forming the anion exchange membrane AEM on the substrate 400. The anion exchange membrane AEM, the second interface additive added into the anion exchange membrane AEM, and so on can refer to the content of the above embodiments, so details are not repeated here.

Then, referring to FIG. 4B, the anion exchange membrane AEM is covered by a porous support material 402. The porous support material 402 has a first side 402a and a second side 402b, and the porous support material 402 contains pores 402p. These pores 402p are exposed at the surface of the first side 402a and the surface of the second side 402b, and the pores 402p in the porous support material 402 are communicated with each other. In one embodiment, it is not needed to perform a drying step before covering the anion exchange membrane AEM by the porous support material 402. In another embodiment, before covering the anion exchange membrane AEM by the porous support material 402, the liquid-state material of the anion exchange membrane AEM can be dried to have a suitable degree of dryness by a heat treatment. The so-called “suitable degree of dryness” means that the material of the anion exchange membrane AEM remains deformable due to force. The degree of dryness may be adjusted by controlling the combination of temperature and time. For example, if the thickness of the membrane is about tens of microns, the drying procedure can be performed at 80-90° C. for 10 minutes, raising the temperature to 100° C.-110° C. and maintaining for 10 minutes, and then raising the temperature to 140-150° C. and maintaining for 10 minutes. However, the disclosure is not limited thereto, and the above drying procedure can be adjusted according to parameters such as the moisture content of the material of the anion exchange membrane AEM or the thickness of the membrane to be formed.

Next, referring to FIG. 4C, the material of the anion exchange membrane AEM penetrates and fills into the pores 402p of the second side 402b of the porous support material 402. In one embodiment, when the porous support material 402 covers the anion exchange membrane AEM, the liquid-state material of the anion exchange membrane AEM can penetrate into the pores 402p at the second side 402b of the porous support material 402 and pass through the pores 402p which are communicated with each other, and thus fill into the porous support material 402. Accordingly, after covering the anion exchange membrane AEM by the porous support material 402, a heat treatment can be performed to completely dry the liquid-state material of the anion exchange membrane AEM. In another embodiment, if the anion exchange membrane AEM has been heat treated and dried to a suitable degree of dryness, the covering step can be directly performed; alternatively, the material of the anion exchange membrane AEM may be allowed to penetrate into the pores 402p by a hot rolling process through a roller.

Then, referring to FIG. 4D, a first interface additive 404 can be optionally added on the first side 402a of the porous support material 402. The contents related to the first interface additive 404 may reference to those in the second embodiment, so details are not repeated here. In addition, the step in FIG. 4D can also be omitted.

Then, referring to FIG. 4E, a cation exchange membrane CEM is formed on the first side 402a of the porous support material 402. The cation exchange membrane CEM can refer to the related content of the first embodiment, so it will not be repeated. Furthermore, the methods of forming the cation exchange membrane CEM on the first side 402a of the porous support material 402 include but are not limited to coating, hot pressing, or hot sticking. The aforementioned coating procedure refers to preparing a polymer solution containing the material of the cation exchange membrane CEM, and then coating the polymer solution on the first side 402a of the porous support material 402 while the completely dried anion exchange membrane AEM is disposed on the second side 402b. The aforementioned hot pressing and hot sticking both refer to preparing a polymer solution containing the material of the cation exchange membrane CEM, coating the polymer solution on another substrate (not shown) and making the liquid-state material of the cation exchange membrane CEM to have a suitable degree of dryness by using heat treatment, and then placing the cation exchange membrane CEM towards the porous support material 402 to be on the first side 402a of the porous support material 402.

Next, referring to FIG. 4F, a suitable pressure is applied, so that the material of the cation exchange membrane CEM penetrates and fills into the pores 402p at the first side 402a, and the material of the cation exchange membrane CEM is not in contact with the material of the anion exchange membrane AEM. During the coating process, the liquid-state material of the cation exchange membrane CEM is completely dried by the heat treatment. During the process of hot pressing and hot pasting, the cation exchange membrane CEM which have been dried to a suitable degree of dryness and the anion exchange membrane AEM are slightly melted by a high temperature and a pressure by means of flat hot pressing, and the materials thereof penetrate into the pores 402p of the first side 402a and the second side 402b of the porous support material 402 respectively. Since the hot sticking includes the process (that is, the step shown in FIG. 4C) of making the material of the anion exchange membrane AEM to penetrate into the pores 402p by rolling, the hot sticking can make the distance between the cation exchange membrane CEM and the anion exchange membrane AEM smaller, which is conducive to ion transmission.

Several experiments are listed below to verify the effect of the disclosure, but these experiments and their results are not intended to limit the scope of application of the disclosure.

[symbol] Analysis Method

[symbol]

The bipolar membrane was cut into a size of 6.5 cm×8.5 cm and was fixed in the test fixture, and the active area was 5 cm×5 cm.

The anion exchange membrane AEM side of the bipolar membrane was disposed faced the anode, and the cation exchange membrane CEM side of the bipolar membrane was disposed faced the cathode. The electrode nets were correspondingly placed on both sides of the bipolar membrane, a distance between the electrode net and the bipolar membrane was 0.5 cm, and the anode electrode net and the cathode electrode net were respectively an iridium-tantalum-titanium net and a platinum-titanium net.

The anolyte and the catholyte were 2M KOH(aq), 1M H₂SO₄(aq), respectively.

The final current-voltage curve of the bipolar membrane was obtained by using a potentiostatic ammeter (Autolab PGSTAT30/Booster 10A) with the settings of voltage scanning range of 0.3V-2.0V.

The specific surface area (BET) of the interface additive was measured using a specific surface area analyzer (BET) (Micromeritics ASAP 2020). The steps of the measurement were: (1) weighing the weight of the empty sample tube; (2) filling the sample tube with the sample and weighing; (3) after degassing by the machine, weighing and calculating to obtain the sample weight; and (4) measuring and analyzing the specific surface area by the analyzer.

### <Experimental Example 1>

### Raw Material:

1. Cation exchange membrane (CEM): Nafion™ (the polymer represented by formula 1, wherein n=7, m=1, and x=10) 20% Dispersion DE2020 (DuPont);
2. Second interface additive: aluminum oxide (Al₂O₃) nanopowder, with particle size less than 50 nm;
3. Porous support material: GF40 glass fiber cloth 1080/FE, Taiwan Dehong (GLOTECH INDUSTRIAL CORP.); and
4. Anion exchange membrane (AEM): preparing the polymer represented by formula 8 according to the embodiment of patent application of TW I583708B.

The steps for preparing the bipolar membrane were as follows.

First, the material of AEM was added into a solvent (dimethylacetamide, DMAc) to prepare a polymer solution.

Then, 10 wt % Al₂O₃ was added to the polymer solution, and an anion exchange membrane was formed by coating the solution with a doctor blade. After that, a glass fiber cloth (having thickness of 40 μm) was put on the anion exchange membrane, and the formed membrane was dried with an infrared (IR) light source and then cooled down for later use.

A cation exchange membrane was formed by coating a Nafion/DMAc solution on the surface of the glass fiber cloth with the doctor blade, and the cation exchange membrane was dried with the IR light source, a bipolar membrane of Experimental Example 1 was obtained. In the formed bipolar membrane, the anion exchange membrane has a thickness of 45 μm, and the cation exchange membrane has a thickness of 50 μm.

After analysis, the current density at 1.2V was 86 mA/cm².

### <Comparative Example 1>

The same materials of AEM and CEM as Experimental Example 1 were used, but there was no porous support material.

The material of AEM was added into a solvent (DMAc) to prepare a polymer solution, and an anion exchange membrane was formed by coating the polymer solution with a doctor blade. Then, the formed membrane was dried with an IR light source and then cooled down for later use.

Next, a cation exchange membrane was formed on the surface of AEM by coating a Nafion/DMAc solution with the doctor blade, and dried with the IR light source, a bipolar membrane of Comparative Example 1 was obtained. In the formed bipolar membrane, the anion exchange membrane has a thickness of 30 μm, and the cation exchange membrane has a thickness of 60 μm.

After analysis, the current density at 1.2V was 63 mA/cm². Thus, the bipolar membrane of Comparative Example 1 without a porous support material is significantly lower than the bipolar membrane of the disclosure in terms of current density.

### <Experimental Example 2>

The same raw materials as Experimental Example 1 were used, but the anion exchange membrane (AEM) was replaced with the polymer represented by formula 9 and prepared according to the embodiment of patent application of TW I612089B.

The steps for preparing the bipolar membrane were as follows.

First, the material of AEM was added into a solvent (dimethylacetamide, DMAc) to prepare a polymer solution.

Then, an anion exchange membrane was formed by coating the solution with a doctor blade, and a glass fiber cloth (having thickness of 40 μm) was put on the anion exchange membrane. After that, the formed membrane was dried with an infrared (IR) light source and then cooled down for later use.

A cation exchange membrane was formed on the surface of the glass fiber cloth by coating a Nafion/DMAc solution with the doctor blade, and was dried with the IR light source, a bipolar membrane of Experimental Example 2 was obtained. In the formed bipolar membrane, the anion exchange membrane has a thickness of 40 μm, and the cation exchange membrane has a thickness of 90 μm.

After analysis, the current density at 1.2V was 85 mA/cm².

### <Experimental Example 3>

The same raw materials as Experimental Example 1 were used. The steps for preparing the bipolar membrane were as follows.

First, the material of AEM was added into a solvent (DMAc) to prepare a polymer solution.

Then, an anion exchange membrane was formed by coating the solution with a doctor blade, and a glass fiber cloth (having thickness of 40 μm) was put on the anion exchange membrane. After that, the formed membrane was dried with an IR light source to a suitable degree of dryness and then cooled down for later use. The drying procedure was maintaining the temperature at 80-90° C. for 10 minutes, raising the temperature to 100° C.-110° C. and maintaining for 10 minutes, and then raising the temperature to 140-150° C. and maintaining for 10 minutes.

In addition, a Nafion/DMAc solution was coated on a surface of a polyethylene terephthalate (PET) substrate with the doctor blade, and the coating was dried with the IR light source to form a cation exchange membrane layer for later use.

Afterwards, the above cation exchange membrane was placed on the surface of the anion exchange membrane/glass fiber cloth composite, so that the order thereof was cation exchange membrane/glass fiber cloth/anion exchange membrane. Then, the formed membranes were hot pressing with a hot-pressing machine at 130° C. for 3 minutes, a bipolar membrane was obtained. In the formed bipolar membrane, the anion exchange membrane has a thickness of 15 μm, and the cation exchange membrane has a thickness of 50 μm.

After analysis, the current density at 1.2V was 112 mA/cm². Therefore, the bipolar membrane produced by hot pressing has a better current density than the bipolar membrane produced by coating (Experimental Example 1).

### <Experimental Example 4>

The same materials of AEM and porous support material as Experimental Example 1 were used. However, the material of CEM was replaced with the polymer represented by formula 5 and prepared according to the embodiment of patent application of TW I717789B, and in formula 5, a is 0.24, b is 0.16, and c is 0.6.

The steps for preparing the bipolar membrane were as follows.

First, the material of AEM was added into a solvent (DMAc) to prepare a polymer solution.

Then, an anion exchange membrane was formed by coating the solution with a doctor blade, and a surface of the formed membrane was dried with an IR light source to a suitable degree of dryness as described in Experimental Example 3. After that, a glass fiber cloth (having thickness of 40 μm) was put on the anion exchange membrane, and the glass fiber cloth and the anion exchange membrane were laminated by rolling at 100° C.

In addition, a mixed solution of the material of CEM and DMAc was coated on the surface of a PET substrate with the doctor blade, and the coating was dried with the IR light source to form an anion exchange membrane layer for later use.

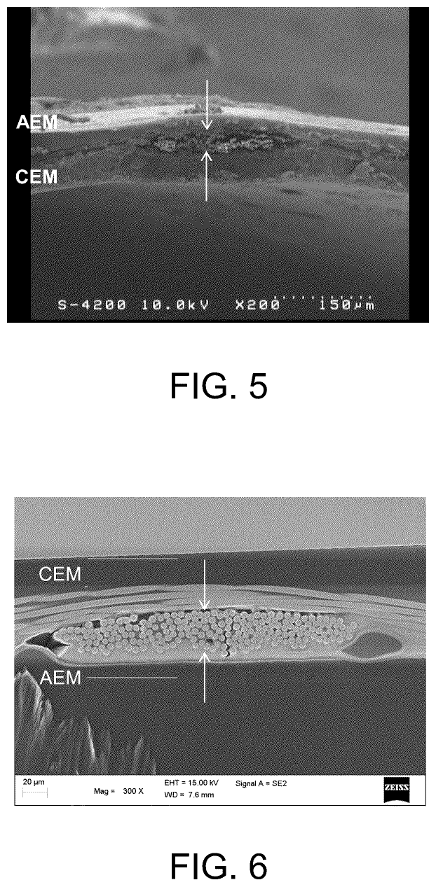

Afterwards, the above cation exchange membrane was placed on the surface of the anion exchange membrane/the glass fiber cloth composite, so that the order thereof was cation exchange membrane/glass fiber cloth/anion exchange membrane. Then, the formed membranes were laminated by rolling at 100-105° C., to form a bipolar membrane as shown in FIG. 5. In the formed bipolar membrane, the anion exchange membrane has a thickness of 25 μm, and the cation exchange membrane has a thickness of 50 μm. As shown in FIG. 5, the area indicated by two arrows in the SEM image is the glass fiber cloth.

After analysis, the current density at 1.2V can be as high as 203 mA/cm².

### <Experimental Example 5>

A bipolar membrane was prepared in the same manner as Experimental Example 4, but the thickness of the anion exchange membrane is 20 μm, and the thickness of the cation exchange membrane is 45 μm.

After analysis, the current density at 1.2V was 171 mA/cm².

### Experimental Example 6-8

A bipolar membrane was prepared in the same manner as Experimental Example 4, but with the following two differences. The first one was that the material of CEM was also the polymer represented by formula 5, but in formula 5, a is 0.32, b is 0.17, and c is 0.42. The second one was to adjust the coating gap formed by the doctor blade in the step of coating the anion exchange membrane, so that the thickness of the dried membrane of the anion exchange membrane is 15 μm, 20 μm, and 25 μm respectively. The thickness of the cation exchange membrane remains 50 μm. In Experimental Examples 6-8, the distance between the anion exchange membrane and the cation exchange membrane is 30 μm.

FIG. 6 is the SEM image of the bipolar membrane of Experimental Example 8, in which the thickness of the anion exchange membrane is 25 μm, and the thickness of the cation exchange membrane is 50 μm. The area indicated by two arrows in FIG. 6 is the glass fiber cloth.

Table 1 shows the results obtained after analysis.

TABLE 1

| Experimental | Ratio of thickness | Current density (mA/cm²) |
|---|---|---|
| Example | (AEM/CEM) | (at 1.2 V) |
| 6 | 15/50 = 0.3 | 189 |
| 7 | 20/50 = 0.4 | 182 |
| 8 | 25/50 = 0.5 | 169 |

It can be obtained from Table 1 that the current density is excellent when the ratio of thickness is between 0.3 and 0.5.

### Comparative Example 2-3

### Raw Material:

1. Comparative Example 2 is BP-1E sold by ASTOM-Japan. It has been measured that the thickness of the AEM is about 77 μm, the thickness of the CEM is about 115 μm, and the AEM and the CEM are in direct contact.
2. Comparative Example 3 is Fumasep FBM sold by FUMATECH-Germany. It has been measured that the thickness of the AEM is about 10 μm, the thickness of the CEM is about 147 m, and the AEM and the CEM are in direct contact.

The same analysis method as other Experimental Examples was adopted, and it was obtained that the current density of Comparative Example 2 at 0.97V was 77 mA/cm², and the current density of Comparative Example 3 at 1.2V was 0.64 mA/cm². It is noted that due to detection limitation of the electrochemical test, the actual current density of Comparative Example 2 at 1.2V can't be measured, so only the highest current density and its corresponding potential were recorded.

Therefore, the bipolar membrane of the disclosure is significantly better than the commercially available membrane in terms of current density.

### Stability Analysis

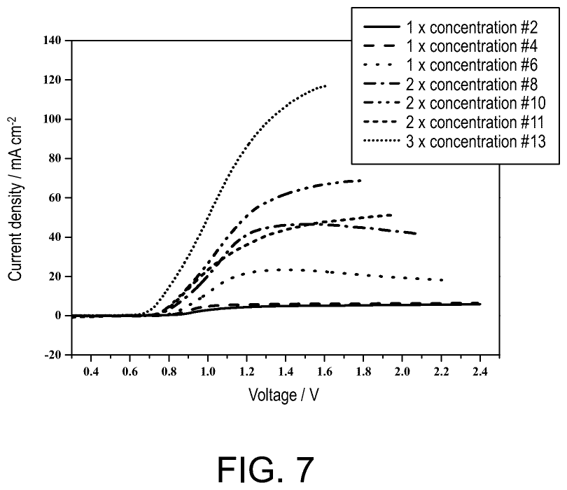

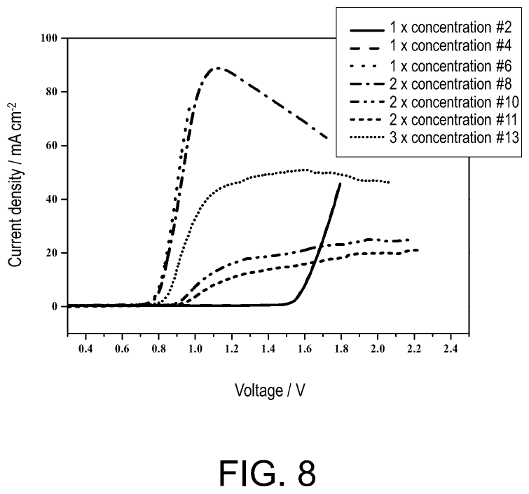

The bipolar membrane of Experimental Example 1 and the BP-1E bipolar membrane of Comparative Example 2 were analyzed in electrolytes with different concentrations, and the results were obtained and shown in FIG. 7 and FIG. 8 respectively. In FIG. 7 and FIG. 8, the original concentration of the electrolyte (represented as 1× concentration) is that the anolyte is 1N KOH and the catholyte is 1N H₂SO₄, and so on. #2, #4 . . . #13 in FIG. 7 and FIG. 8 represent different sample number according to the experimental order.

From the comparison of FIG. 7 and FIG. 8, it can be obtained that as the concentration of the electrolyte increases, the overall performance of the BP-1E bipolar membrane in Comparative Example 2 is unstable due to poor chemical resistance.

In addition, from the visual observation, it was observed that the BP-1E bipolar membrane of Comparative Example 2 reacted at a high electrolyte solution concentration, and foaming and interfacial peeling occurred.

Therefore, compared with the commercially available membrane of Comparative Example 2, the bipolar membrane of Experimental Example 1 has more stable operating property.

### Experimental Example 9-13

The same raw materials as Experimental Example 6 were used, and an acidified conductive carbon material serving as the first interface additive was additionally prepared in the following manner.

### Conductive Carbon Material Specifications:

ECP300: EC300J purchased from KETJENBLACK, BET (specific surface area): 800 m²/g; and
ECP600: EC600JD purchased from Ketjen Black, BET: 1270 m²/g.

### Acidification Process:

15 g of conductive carbon material was added to 600 ml of concentrated nitric acid (HNO₃, 60˜70%), and the mixture was stirred at 100° C. for 8 hours and then cooled down to room temperature. The steps of adding water (1 L deionized water), pumping air, and filtering were repeated to obtain a solid carbon material.

Then, the solid carbon material was mixed with deionized water, and then the pH value of the solution was adjusted to 7.0 with ammonia water (NH₃, 35%). After stirring, the solution was pumped and filtered. Then, the steps of adding water (1 L deionized water), pumping air, and filtering were repeated, to obtain an acidified conductive carbon material.

The acidified conductive carbon material was placed in an 80° C. hot air circulation oven to dry for 24 hours, and then was cooled down, grinded and stored. The acidified conductive carbon material was sieved (with 150 mesh sieve) before use.

The acidified conductive carbon material is represented by HECP300 and HECP600, and the hydrophilic degree of the surface and BET of HECP300 and HECP600 are as follows,
HECP300: number of hydrophilic groups=2.33 mmol/g, BET: 552 m²/g; and
HECP600: number of hydrophilic groups=4.42 mmol/g, BET: 405.5 m²/g.

The steps for preparing the bipolar membrane were as follows.

First, the material of AEM was added into a solvent (DMAc) to prepare a polymer solution. Then, an anion exchange membrane was formed by coating the polymer solution with a doctor blade, and the formed membrane was dried with an IR light source to a suitable degree of dryness as described in Experimental Example 3. After that, a glass fiber cloth (having thickness of 40 μm) was put on the anion exchange membrane, and the glass fiber cloth and the anion exchange membrane were laminated by rolling at 100° C. The thickness of the anion exchange membrane is 15 μm.

Then, a coating slurry containing a first interface additive was prepared, and the type and content of the first interface additive were respectively recorded in Table 2 below. The coating slurry includes the first interface additive, a solvent (DMAc), and material of CEM serving as an adhesive. After mixing and dispersing, the coating slurry was coated on the surface of the glass fiber cloth with a doctor blade, and then the coating was dried with an IR light source. After that, the first interface additive was weighed to calculate the content.

Next, a mixed solution of the material of CEM and DMAc was coated on the surface of a PET substrate with the doctor blade, and the coating was dried with an IR light source to a suitable degree of dryness as described in Experimental Example 3.

Afterwards, the above cation exchange membrane was placed on the surface of the anion exchange membrane/the glass fiber cloth with the first interface additive composite, so that the order thereof was anion exchange membrane/glass fiber cloth/cation exchange membrane. Then, the above membranes were combined by rolling, a bipolar membrane was obtained. The cation exchange membrane has a thickness of 50 μm.

After analysis, the current density was also recorded in Table 2 below.

TABLE 2

| Experimental | First interface | Content | Current density (mA/cm²) |
|---|---|---|---|
| Example | additive | (mg/cm²) | (at 1.2 V) |
| 9 | HECP300 | 0.004 | 81.2 |
| 10 | HECP300 | 0.007 | 136.0 |
| 11 | HECP300 | 0.013 | 139.8 |
| 12 | HECP600 | 0.016 | 157.9 |
| 13 | HECP600 | 0.044 | 220.6 |
| | | | (corresponding to 1.19 V) |

Due to the detection limitation of the electrochemical test, the actual current density of Experimental Example 13 at 1.2V can't be measured, so only the highest current density and its corresponding potential were recorded.

It can be obtained from Table 2 that the addition of the acidified conductive carbon material as the first interface additive can improve the current density, and with the increase of the hydrophilic degree of the surface of the first interface additive or the increase of the content of the first interface additive, the current density can be further improved.

### <Experimental Example 14-18>

A bipolar membrane was prepared in the same manner as Experimental Example 13, but the first interface additive was replaced with the metal oxide powder in Table 3 below.

### Metal Oxide Specifications:

B₂O₃: boron oxide, ˜60 mesh.
TiO₂: anatase titanium dioxide (Nanostructure & Amorphous Materials Inc.), with a particle size of about 15 nm; and
SiO₂: AEROSIL R504 (Evonik).

The current densities obtained after the analysis are also described in Table 3 below.

TABLE 3

| Experimental | First interface | Content | Current density (mA/cm²) |
|---|---|---|---|
| Example | additive | (mg/cm²) | (at 1.2 V) |
| 14 | B₂O₃ | 0.121 | 160.1 |
| 15 | TiO₂ | 0.069 | 237.0(corresponding |
| | | | to 1.18 V) |
| 16 | TiO₂ | 0.130 | 222.9(corresponding |
| | | | to 1.15 V) |
| 17 | SiO₂ | 0.052 | 205.7 |
| 18 | SiO₂ | 0.141 | 231.4(corresponding |
| | | | to 1.15 V) |

Due to the detection limitation of the electrochemical measuring equipment, the actual current densities of Experimental Examples 15, 16 and 18 at 1.2V can't be measured, so only the highest current densities and their corresponding potentials are recorded.

It can be obtained from Table 3 that addition of the metal oxide powder as the first interface additive can also improve the current density.

### <Experimental Example 19>

The same raw materials as Experimental Example 6 were used, but the porous support material was replaced with electrospun polyvinylidene fluoride (PVDF) nanofiber membrane. The detailed preparation parameters and methods of the electrospun PVDF nanofiber membrane was as follows.
(1) weight average molecular weight Mw of PVDF-HFP (polyvinylidene fluoride-hexafluoropropylene) raw material: ˜400,000 (Sigma-Aldrich);
(2) electrospinning polymer solution: PVDF-HFP/DMAc with solid content of 20.63 wt %; and
(3) electrospinning parameters:
   i. working distance (the distance from the tip to the collector): 12 cm
   ii. working voltage: 24 kV
   iii. syringe flow rate: 2.5 ml/h
   iv. syringe needle number 18 G
   v. temperature: 29.8° C.; and
   vi. humidity: 38% RH.

The electrospinning time was 7 minutes, and the thickness of the PVDF-HFP nanofiber membrane was 7 to 10 μm.

The steps for preparing the bipolar membrane were as follows.

First, the material of AEM was added into a solvent (DMAc) to prepare a polymer solution. Then, an anion exchange membrane was formed by coating the polymer solution with a doctor blade, and the formed membrane was dried with an IR light source to a suitable degree of dryness as described in Experimental Example 3. After that, a PVDF-HFP nanofiber membrane was put on the anion exchange membrane, and the PVDF-HFP nanofiber membrane and the anion exchange membrane were laminated by rolling at 100° C. The thickness of the anion exchange membrane is 15 μm.

Next, a mixed solution of the material of CEM and DMAc was coated on the surface of a PET substrate with the doctor blade, and the coating was dried with the IR light source to a suitable degree of dryness as described in Experimental Example 3.

Afterwards, the above cation exchange membrane was placed on the surface of the anion exchange membrane/the PVDF-HFP nanofiber membrane composite, so that the order thereof is cation exchange membrane/PVDF-HFP nanofiber membrane/anion exchange membrane. Then, the above membranes were combined by rolling to form a bipolar membrane. The cation exchange membrane has a thickness of 50 μm.

After analysis, the current density at 1.2V was 61 mA/cm².

### <Experimental Example 20>

The same preparation method and raw materials as Experimental Example 6 were used, but the porous support material was replaced with a non-woven graphene fabric having a thickness of 95-105 μm (purchased from Xincai Industrial Co., Ltd.).

After analysis, the current density at 1.2V was 132 mA/cm².

Therefore, it can be obtained from Experimental Examples 19-20 that the use of different porous support materials also has an improvement.

In summary, the bipolar membrane of the disclosure includes the cation exchange membrane and the anion exchange membrane separated by the porous support material, and the cation exchange membrane and the anion exchange membrane penetrate into the pores of both sides of the porous support material. Thus, the electrochemical properties of the membrane and interface stability are improved, and the strength of the bipolar membrane is also improved. In addition, by adding the interface additives, the water balance and/or ion transport balance of the cation exchange membrane and/or the anion exchange membrane can be improved, thereby improving conductivity.

Although the disclosure has been disclosed above with the embodiments, it is not intended to limit the disclosure. Anyone with ordinary knowledge in the technical field can make some changes and modifications without departing from the spirit and scope of the disclosure. The scope of protection of the disclosure should be defined by the scope of the appended patent application.

What is claimed is:

1. A bipolar membrane, comprising:
a porous support material, having opposing first and second sides;
a cation exchange membrane, disposed on the first side of the porous support material, wherein a material of the cation exchange membrane penetrates into pores of the first side and combines with the porous support material; and
an anion exchange membrane, disposed on the second side of the porous support material, wherein a material of the anion exchange membrane penetrates into pores of the second side and combines with the porous support material, and
the cation exchange membrane is not in contact with the anion exchange membrane.

2. The bipolar membrane of claim 1, wherein the porous support material includes a glass fiber cloth, an electrospun polyvinylidene fluoride (PVDF) nanofiber membrane, a non-woven graphite cloth, or a polymer fabric.

3. The bipolar membrane of claim 1, wherein a ratio of a thickness of the anion exchange membrane to a thickness of the cation exchange membrane is 0.3-1.

4. The bipolar membrane of claim 1, wherein a distance between the cation exchange membrane and the anion exchange membrane is less than 30 μm.

5. The bipolar membrane of claim 1, further comprising a first interface additive disposed in the cation exchange membrane and located on the first side of the porous support.

6. The bipolar membrane of claim 5, wherein the first interface additive includes acidified conductive carbon material or metal oxide powder.

7. The bipolar membrane of claim 6, wherein a specific surface area of the acidified conductive carbon material is above 390 m²/g.

8. The bipolar membrane of claim 6, wherein a surface of the acidified conductive carbon material has a carbonyl group, a carboxyl group, or a nitrate group.

9. The bipolar membrane of claim 1, further comprising a second interface additive evenly dispersed in the anion exchange membrane.

10. The bipolar membrane of claim 9, wherein the second interface additive includes acidified conductive carbon material or metal oxide powder.

11. The bipolar membrane of claim 10, wherein a specific surface area of the acidified conductive carbon material is above 390 m²/g.

12. The bipolar membrane of claim 10, wherein a surface of the acidified conductive carbon material has a carbonyl group, a carboxyl group or a nitrate group.

13. The bipolar membrane of claim 1, wherein the material of the cation exchange membrane includes a polymer represented by formula 1, 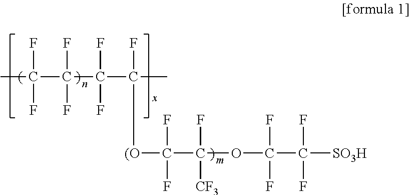
in formula 1, n is 5-14, m is 1-2, and x is 200-1000.

14. The bipolar membrane of claim 1, wherein the material of the cation exchange membrane includes a polymer having repeating units represented by formula 2, formula 3 and formula 4, 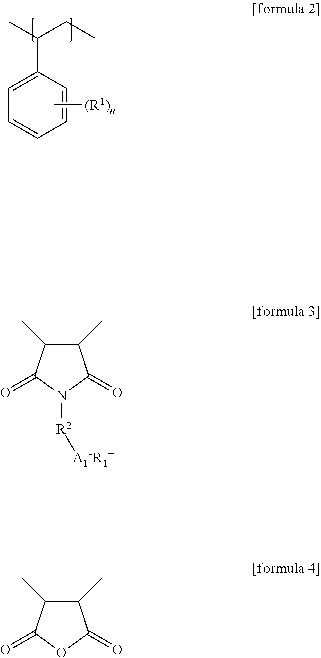
in formula 2, R¹ represents C₁-C₈ alkyl group, C₁-C₈ cycloalkyl group, C₁-C₈ alkoxy group or C₁-C₈ alkoxyalkyl group, and n is 0 or an integer of 1-5; and
in formula 3, R² represents C₆-C₁₆ arylene group, C₁-C₈ alkylene group, C₁-C₈ cycloalkylene group or C₁-C₈ alkoxy alkylene group, A₁⁻ represents SO₃⁻, NO₃⁻ or COO⁻, and R₁⁺ represents H⁺, Li⁺, Na⁺, K⁺ or NH₄⁺.

15. The bipolar membrane of claim 1, wherein the material of the anion exchange membrane includes a polymer having repeating units represented by formula 6 and formula 7, 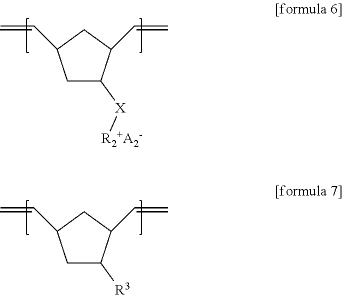
in formula 6, X represents [symbol] CH₂ [symbol] Y [symbol] CH₂ [symbol] , i and j are each independently 0 or an integer of 1-6, and Y is —O—, —S—, —CH₂— or —NH—; A₂ represents F⁻, Cl⁻, Br⁻, I⁻, OH, HCO₃⁻, HSO₄⁻, SbF₆⁻, BF₄⁻, H₂PO₄⁻, H₂PO₃⁻ or H₂PO₂⁻; and R₂⁺ represents 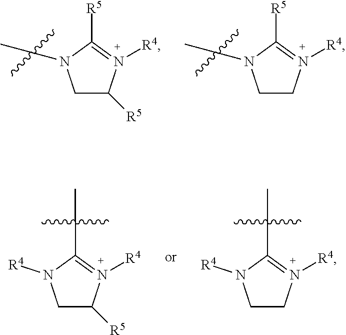
wherein R⁴ and R⁵ are independently hydrogen or C₁-C₈ alkyl group; and
in formula 7, R³ represents a C₁-C₈ alkyl group.

16. The bipolar membrane of claim 1, wherein the anion exchange membrane includes a polymer polymerized by a styrene-based monomer, an ammonium-containing heterocyclic monomer and a monomer having conjugated double bonds or an acrylate ester monomer.

17. A method of manufacturing a bipolar membrane, comprising:
forming an anion exchange membrane on a substrate;
covering a porous support material having opposing first and second sides on the anion exchange membrane, and allowing a material of the anion exchange membrane to penetrate and fill into pores of the second side of the porous support material;
forming a cation exchange membrane on the first side of the porous support material, and allowing a material of the cation exchange membrane to penetrate and fill into pores of the first side of the porous support material, wherein the material of the cation exchange membrane is not in contact with the material of the anion exchange membrane; and
removing the substrate.

18. The method of claim 17, further comprising: adding a first interface additive on the first side of the porous support material before forming the cation exchange membrane.

19. The method of claim 17, wherein forming the anion exchange membrane comprises:
adding a second interface additive on the substrate during forming the anion exchange membrane.
